(19) United States
(12) Patent Application Publication
(10) Pub. No.: US 2019/0191002 A1
(43) Pub. Date: Jun. 20, 2019

(54) SYSTEM AND METHODS FOR WEATHER SATELLITE CONTENT DELIVERY

(71) Applicant: ATC Technologies, LLC, Reston, VA (US)

(72) Inventors: Maqbool Aliani, Fairfax, VA (US); Ismael Garcia, Purcellville, VA (US); Katya Share, Broadlands, VA (US); Oleksiy Shevchenko, Broadlands, VA (US); Shervin Gerami, Ashburn, VA (US)

(21) Appl. No.: 15/875,601

(22) Filed: Jan. 19, 2018

Related U.S. Application Data
(60) Provisional application No. 62/598,790, filed on Dec. 14, 2017.

(51) Int. Cl. H04L 29/08; H04L 12/24

(52) U.S. Cl. CPC H04L 67/26; H04L 67/12; H04B 7/18523; H04L 67/1097; H04L 67/36; H04L 41/5054

(57) ABSTRACT

System and methods for weather satellite content delivery. One system includes a weather satellite, a region receiver that receives weather data from the satellite, and a content delivery network. The content delivery network includes a plurality of data centers and an operation center communicatively coupled to the data centers and the region receiver. The operation center receives the weather data from the region receiver and stores the data within at least one of the data centers. The operation center receives, from a computing device, a user login request to initiate a virtual private cloud and, in response to the user login request, initiates the virtual private cloud in communication with the computing device. The operation center receives, through the virtual private cloud, a weather data request, and, in response to the request, transmits the weather data to the computing device for display on a user interface.

### RELATED APPLICATION

The present application claims the benefit of co-pending U.S. Provisional Patent Application No. 62/598,790, filed Dec. 14, 2017, the entire contents of which is hereby incorporated by reference.

### FIELD

Embodiments described herein relate to satellite and terrestrial communications systems and, more particularly, to weather satellite content delivery to Earth-based systems.

### BACKGROUND

Satellite communications systems are widely used for content delivery to Earth-based systems and devices. Such systems generally employ at least one space-based component, such as one or more satellites, that are configured to wirelessly communicate with devices on the Earth. One particular application of satellite communications is the use of space-based weather satellites to monitor and collect data regarding the Earth's weather. Weather data is gathered and distributed by the National Oceanographic and Atmospheric Administration (NOAA).

### SUMMARY

NOAA weather data is only available with access to the NOAA satellite via a professionally-installed receiving satellite dish. In order to distribute the data, end users must request the data directly from the location of the receiving satellite dish. As a result, there is a sizable “last-mile” gap between the generation and transmission of NOAA weather data from the satellite and its distribution. This gap may result in latent or lossy transmission of the data.

To help bridge this significant gap and make weather data more accessible, embodiments described herein provide, among other things, a scalable content delivery network, which includes a cloud platform for universal access via a customized user interface. Both near real-time and archived NOAA weather satellite data is made available to be pushed or pulled so that information is streamed in the content delivery network to multiple users via, for example, commercial internet or private network access using a simplified access system.

One example embodiment provides a content delivery system. The system includes a weather satellite, a region receiver, and a content delivery network. The region receiver is configured to receive weather data from the weather satellite. The content delivery network includes a plurality of data centers and an operation center communicatively coupled to the plurality of data centers and the region receiver. The operation center is configured to receive the weather data from the region receiver. The operation center is configured to store the weather data within at least one of the plurality of data centers. The operation center is configured to receive, from a computing device, a user login request to initiate a virtual private cloud associated with the user login request. The operation center is configured to, in response to the user login request, initiate the virtual private cloud. The virtual private cloud is in communication with the computing device. The operation center is configured to receive, through the virtual private cloud, a weather data request. The operation center is configured to, in response to the weather data request, transmit the weather data to the computing device for display on a user interface of the computing device.

Another example embodiment provides a method of content delivery. The method includes receiving, from a region receiver, weather data from a weather satellite. The method includes storing the weather data within at least one of a plurality of data centers of a content delivery network. The method includes receiving, from a computing device, a user login request to initiate a virtual private cloud associated with the user login request. The method includes in response to the user login request, initiating the virtual private cloud, wherein the virtual private cloud is in communication with the computing device. The method includes receiving, through the virtual private cloud, a weather data request. The method includes, in response to the weather data request, transmitting the weather data to the computing device for display on a user interface of the computing device.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a content delivery system according to some embodiments.

FIG. 2 is a diagram of a top level architecture of the content delivery system according to some embodiments.

FIG. 3 is a diagram of a virtual private cloud initiated by the content delivery system of FIG. 1 according to some embodiments.

FIG. 4 is a flowchart or a content delivery method according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments described herein provide, among other things, a scalable Content Delivery Network (CDN), which provides geographically distributed server nodes for users to receive weather data and files. The nodes are therefore closer to end-user systems, providing a faster response and download time for the content because of reduced latency. Each CDN node (also referred to herein as an edge server) caches the content from the data source. Typically, the “original” version of a file is stored on a central server or server farm, and copies of the file are distributed to distributed CDN servers across a regional or global network. When an end user requests a weather data file, the CDN fulfills the request and delivers the file from the CDN servers that are located physically closest to the end user. The CDN system can also push file download requests to users' systems for automatic weather content delivery. The current satellite-based delivery system requires users to maintain all downloaded files in the event they need access to them again. Average data stream sizes of tens of terabytes per month pose a significant challenge for the users. This affects cost, reliability, access, and search complexity. Cloud-based delivery systems in accordance with one or more embodiments allow users to work with archived files, providing improved search capabilities and increased usability. This also eliminates the need for users to deploy complex storage systems and incur large maintenance costs.

Before any embodiments of the invention are explained in detail, it is to be understood that the invention is not limited in its application to the details of construction and the arrangement of components set forth in the following description or illustrated in the following drawings. The invention is capable of other embodiments and of being practiced or carried out in various ways.

It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, all or some of the electronics based aspects of the invention may be implemented in software (e.g., stored on non-transitory computer-readable medium) executable by one or more electronic processors. As such, it should be noted that a plurality of hardware and software based devices, as well as a plurality of different structural components may be utilized to implement the invention. For example, “control units” and “controllers” described in the specification can include one or more electronic processors, one or more memory modules including non-transitory computer-readable medium, one or more input/output interfaces, and various connections (e.g., a system bus) connecting the components.

One example embodiment provides a content delivery system. The system includes a weather satellite, a region receiver, and a content delivery network. The region receiver is configured to receive weather data from the weather satellite. The content delivery network includes a plurality of data centers and an operation center communicatively coupled to the plurality of data centers and the region receiver. The operation center is configured to receive the weather data from the region receiver. The operation center is configured to store the weather data within at least one of the plurality of data centers. The operation center is configured to receive, from a computing device, a user login request to initiate a virtual private cloud associated with the user login request. The operation center is configured to, in response to receiving the user login request, initiate the virtual private cloud, wherein the virtual private cloud is in communication with the computing device. The operation center is configured to receive, through the virtual private cloud, a weather data request. The operation center is configured to, in response to receiving the weather data request, transmit the weather data to the computing device to process or store the weather data and/or for display on a user interface of the computing device.

Another example embodiment provides a method for content delivery. The method includes receiving, from a region receiver, weather data from a weather satellite. The method includes storing the weather data within at least one of a plurality of data centers of a content delivery network. The method includes receiving, from a computing device, a user login request to initiate a virtual private cloud associated with the user login request. The method includes, in response to receiving the user login request, initiating the virtual private cloud. The virtual private cloud is in communication with the computing device. The method includes receiving, through the virtual private cloud, a weather data request. The method includes, in response to receiving the weather data request, transmitting the weather data to the computing device to process or store the weather data and/or for display on a user interface of the computing device.

For ease of description, each of the exemplary systems or devices presented herein is illustrated with a single exemplar of each of its component parts. Some examples may not describe or illustrate all components of the systems. Other exemplary embodiments may include more or fewer of each of the illustrated components, may combine some components, or may include additional or alternative components.

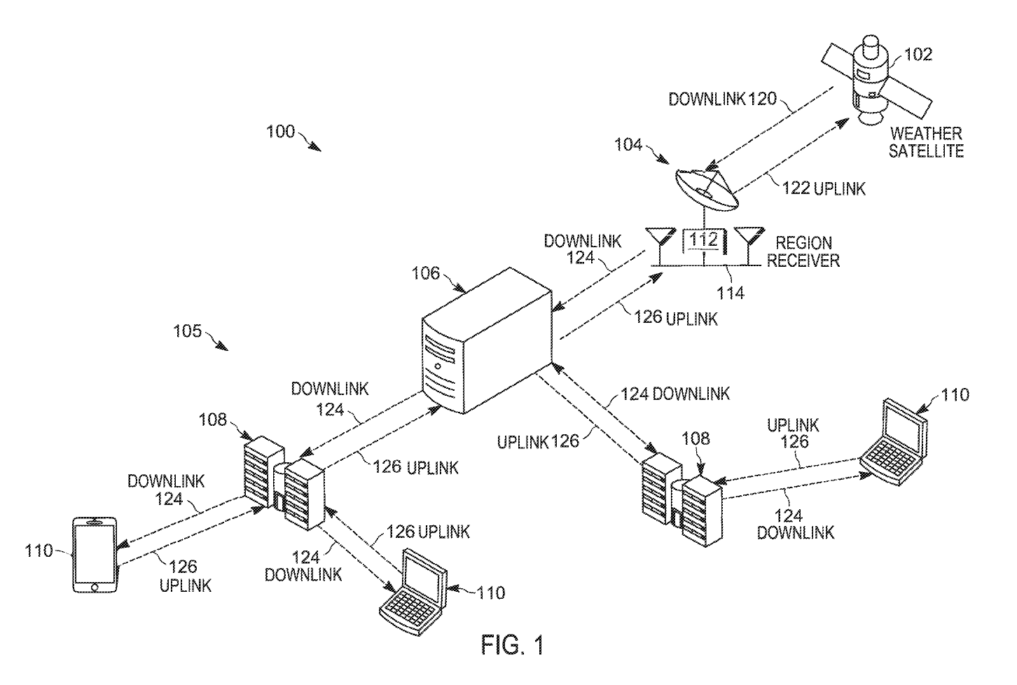

FIG. 1 is a diagram of an example content delivery system 100. The system 100 includes a weather satellite 102, a region receiver 104, and a content delivery network 105. The region receiver 104 includes a satellite antenna 112 and a terrestrial antenna 114. The weather satellite 102 wirelessly communicates with the region receiver 104 via the satellite antenna 112. The weather satellite 102 is a space-based satellite; for example, a geostationary operational environmental satellite (GOES) operated by NOAA. The weather satellite 102 collects and wirelessly transmits weather data (described in more detail below) to the region receiver 104 via a downlink signal 120.

The region receiver 104 wirelessly receives weather data from the weather satellite 102 and wirelessly transmits data to the weather satellite 102 via an uplink signal 122. In some embodiments, the region receiver 104 receives the weather data from the weather satellite 102 via two or more data streams. In some embodiments, the speed of at least one of the data streams is approximately 15.5 Mbps. The region receiver 104 processes and retransmits the downlink signal 120 terrestrially as a repeated downlink signal 124 to an operation center 106. A terrestrial return link signal 126 is received by the region receiver 104, where the signal is amplified and retransmitted as the satellite uplink 122. In some embodiments, more than one of the terrestrial return links (uplink signal 126) is received by the region receiver 104. In such embodiments, the uplink signals 126 are multiplexed onto a common channel using conventional methods. Likewise, the terrestrial uplink signals 126 and downlink signals 124 within the content delivery system 100 may include one or more additional uplink and/or downlink signal lines for redundancy. In some embodiments, the system 100 includes a second region receiver (not shown) configured to receive weather data from the weather satellite 102. The second region receiver also transmits the received weather data to the operation center 106. In some embodiments, the weather data received by the second region receiver is identical to the weather data received and processed by the region receiver 104.

The weather data received and processed by the content delivery system 100 may include one or both of a passive imaging radiometer (for example, an advanced baseline imager (ABI)) data set and a secondary environment instrument data set. The ABI data set includes satellite level images of the Earth's weather, oceans, and environment. Such images may be captured using approximately 16 different spectral bands. The spectral bands may include exclusively or a combination of visible and invisible channels, for example near-infrared and infrared. The ABI data set may include data regarding cloud formation; atmospheric motion; convection; land surface temperature; ocean dynamics; flow patterns of water, fire, smoke, volcanic ash plumes, aerosols, and air quality; storm tracking; and the like. The secondary environment instrument data is data from one or more other kinds of environmental data-collecting instruments. The secondary environment instrument data may include at least one selected from the group consisting of space environment data, geostationary lightning mapper data, ultraviolet and x-ray irradiance data, magnetometer data, and solar ultraviolet imager data.

The space environment data may be collected via one or more types of sensors. Such sensors may include, for example, energetic heavy ion sensors (EHIS), magnetospheric particle sensors (MPS-HI and MPS-LO), solar and galactic proton sensors (SGPS), and the like. The geostationary lightning mapper data includes activity data regarding lightning. Such data may be provided by an optical transient detector (or lightning mapper) configured to detect the momentary changes in an optical scene, which may indicate the occurrence of lightning. The ultraviolet and x-ray irradiance data includes data used to monitor solar irradiance and activity on the sun's surface. Such data may be received from extreme ultraviolet sensors (EUVS), x-ray sensor (XRS), and the like. The magnetometer data may include measurements, collected by a magnetometer, related to the space environment magnetic field. The space environment magnetic field affects charged particle dynamics in the outer region of the magnetosphere. Such data may be used, for example, to detect sudden magnetic storms. The solar ultraviolet imager data includes data related to the sun's ultraviolet wavelength range and characteristics. Such data may be used to estimate coronal plasma temperatures and emission measurements for space weather forecasting.

The content delivery network 105 also includes an operation center 106, a plurality of data centers 108, and a plurality of computing devices 110. The operation center 106 is communicatively coupled to each of the plurality of data centers 108. Each of the plurality of data centers 108 are connected to one or more of the computing devices 110. As described in detail below, the content delivery network 105 operates to provide a weather content delivery service for end users operating the one or more computing devices 110.

The operation center 106 receives the weather data transmitted from the region receiver 104 via the downlink signal 126. The operation center 106 stores the weather data within one or more of the plurality of data centers 108. The operation center 106 includes hardware (for example, servers, switches, routers, transceivers, and the like) and software for receiving, processing, and transmitting data, including weather data. In some embodiments, each of the plurality of data centers 108 includes an edge server wherein the weather data is stored. The weather data is archived at the data centers 108, and may be accessed or received by one or more of the computing devices 110 in response to a user request, as described in greater detail below.

In some embodiments, the computing device 110 is a computer terminal. In other embodiments, the computing device 110 is a server, a network storage device, a server cluster, an virtual machine, a distributed computing system, or other suitable electronic device (for example, a smart telephone, a tablet computer, a laptop computer, a smart watch, and the like) for sending and receiving data to and from the data center 108 (via one or more communication networks). An example computing device includes some or all of an electronic processor, a memory, a display, a data storage device, a communication interface, and a bus. The memory may include an operating system and one or more software applications configured to perform operations as described herein. The electronic processor may include at least one processor or microprocessor that interprets and executes a set of instructions stored in the memory (a non-transitory computer-readable medium). As used in the present application a non-transitory computer-readable medium comprises all computer-readable media except for a transitory, propagating signal. The memory may include random access memory (RAM)), read only memory (ROM), and combinations thereof. The memory may have a distributed architecture, where various components are situated remotely from one another, but may be accessed by the electronic processor.

The data storage device may include a non-transitory, tangible, machine-readable storage medium that stores machine-readable code or instructions. In one example, the data storage device stores a set of instructions detailing a method provided herein that when executed by one or more processors cause the one or more processors to perform the method. The data storage device may also be a database or a database interface for storing an application module. In one example, the data storage device is located external to the computing device 110.

The bus, or other component interconnection, may permit communication among the components of the computing device 110. The bus may be, for example, one or more buses or other wired or wireless connections, as is known in the art. The bus may have additional elements, which are omitted for simplicity, such as controllers, buffers (for example, caches), drivers, repeaters and receivers, or other similar components, to enable communications. The bus may also include address, control, data connections, or a combination of the foregoing to enable appropriate communications among the aforementioned components.

The communication interface provides the computing device 110 with a communication gateway to an external network (for example, a wireless network, a private network, the internet, etc.). The communication interface may include, for example, an Ethernet card or adapter or a wireless local area network (WLAN) card or adapter (for example, IEEE standard 802.11a/b/g/n). The communication interface may include address, control, and/or data connections to enable appropriate communications on the external network.

The various “servers,” “edge servers,” and other computing devices referred to herein include similar components and are configured similarly to the computing device 110.

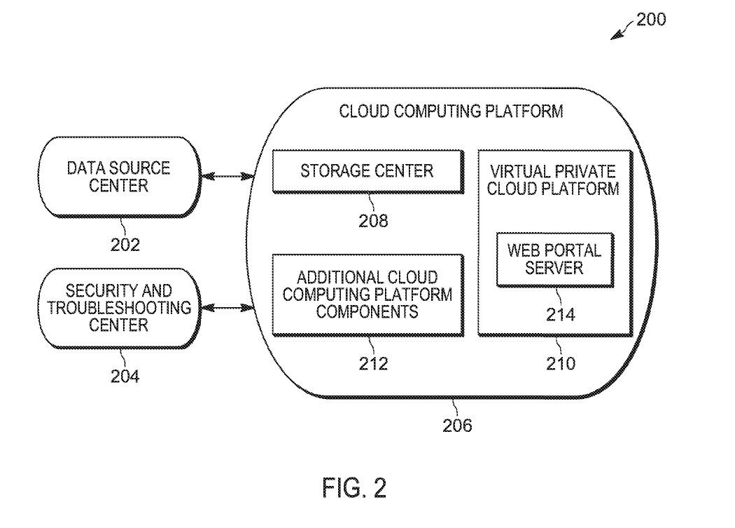

FIG. 2 is a diagram of an example top level architecture 200 of the content delivery system 100. The architecture 200 includes a data source center 202, a security and troubleshooting center 204, and a cloud computing platform 206. The data source center 202 includes suitable computing and telecommunications hardware and software to process the weather data received from the weather satellite 102 to be transmitted to the operation center 106. In some embodiments, the data source center 202 provides emulation of the weather data and redistribution packaging. In some embodiments, the data source center may also provide data integrity preprocessing of the weather data before transmitting the weather data to the operation center 106.

The security and troubleshooting center 204 includes suitable computing and telecommunications hardware and software to provide version control, secure storage for application source code of the system 100, bug tracking, and system recovery procedures and automation for the content delivery system 100.

The cloud computing platform 206 is a cloud service platform for implementing the content delivery network 105. The cloud computing platform 206 includes a storage center 208, a virtual private cloud platform 210, and additional cloud computing platform components 212 (for example, load balancers, system monitors, logic triggers, and the like). The storage center 208 provides storage for the weather data as well as any logs and configuration data related to the system 100. In some embodiments, the storage center 208 includes an electronic data archive for storing previously received weather data.

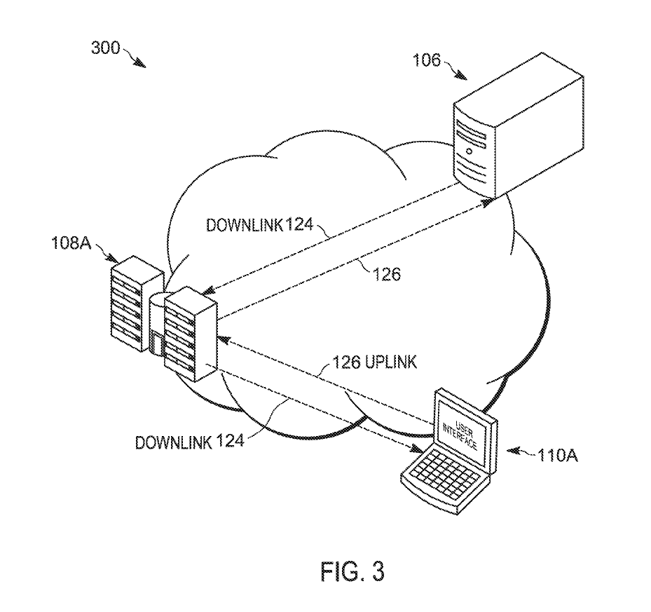

The virtual private cloud platform 210 includes a web portal server 214. The web portal server 214 provides a portal-based user interface that allows an operator of one of the computing devices 110 to interact with the system 100. For example, the operator may submit a login request through the user interface to the web portal server 214. In some embodiments, the web portal server 214 initiates a virtual private cloud 300, illustrated in FIG. 3, in response to a successful user login request.

As illustrated in FIG. 3, the virtual private cloud 300 communicatively connects a computing device 110a (the one of the plurality of computing devices 110 that made the successful user login request), a corresponding data center 108a, and the operation center 106 into a virtual dedicated network. The corresponding data center 108a is the one of the plurality of data centers 108 that is located closest (for example, as a measure of physical distance, network latency, or both) to the computing device 110a. The data center 108a receives, from the computing device 110a, a weather data request and, in response to the weather data request, transmits the weather data to the computing device 110a for display on the user interface of the computing device 110a. In some embodiments, the weather data request is a direct request from the operator of the computing device 110a, for example, received through the user interface. In some embodiments, the data center 108a automatically pushes the weather data to the computing device 110a each time the data center 108a receives new weather data. In some embodiments, the computing device 110a requests previously received weather data via the user interface through the virtual private cloud 300. In response to the request for previously received weather data, the data center 108a transmits the previously received weather data requested to the computing device 110a via the virtual private cloud 300.

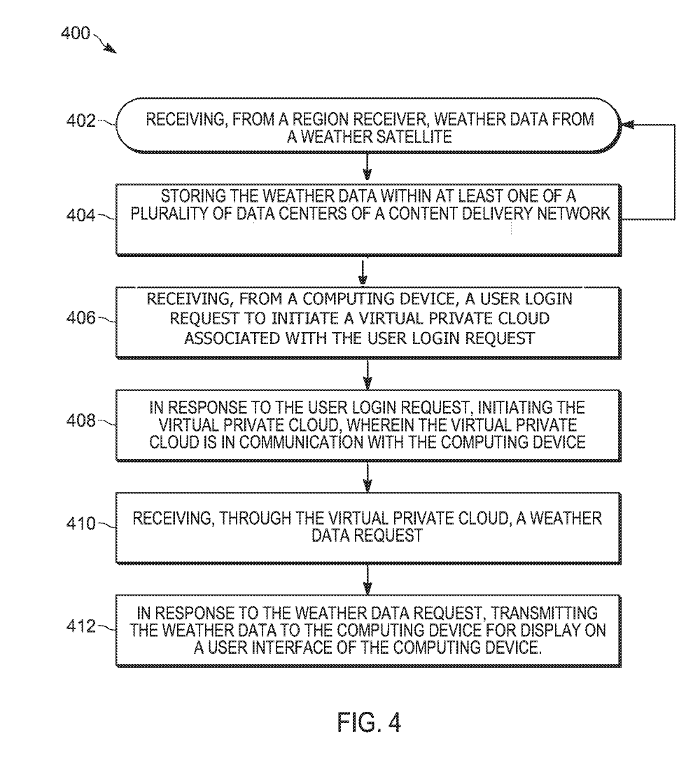

FIG. 4 illustrates an example method 400 for content delivery via the system 100. As an example, the method 400 is described as being performed by the operation center 106 and, in particular, an electronic processor (for example, of a server of the operation center 106). However, it should be understood that in some embodiments, portions of the method 400 may be performed by other computing devices. As an example, the method 400 is described in terms of a single region receiver 104 and a single operation center 106 communicating with a single computing device 110. However, it should be understood that embodiments of the method 400 may be implemented across multiple region receivers, operation centers, and computing devices. At block 402, the operation center 106 receives, from a region receiver (for example, the region receiver 104), weather data. The weather data was received by the region receiver 104 from a weather satellite (for example, the weather satellite 102 in FIG. 1). In some embodiments, the weather data is received in two or more data streams. In some embodiments, the weather data is received by multiple region receivers. At block 404, the operation center 106 stores the weather data within at least one of a plurality of data centers 108 of the content delivery network 105. In one example, the operation center 106 stores the weather data within an edge server of at least one of the plurality of data centers 108. As illustrated in FIG. 4, blocks 402 and 404 are repeated continuously as weather data is generated by the weather satellite 102.

At block 406, the operation center 106 receives, from a computing device (for example, the computing device 110a), a user login request to initiate a virtual private cloud associated with the user login request. At block 408, in response to receiving the user login request, the operation center 106 initiates the virtual private cloud (for example, as described above with respect to FIG. 3). After initiation, the virtual private cloud is in communication with the computing device 110a.

At block 410, the operation center 106 receives, through the virtual private cloud 300, a weather data request. At block 412, in response to receiving the weather data request, the operation center 106 transmits the weather data to the computing device 110a for display on a user interface of the computing device 110a and/or for processing the weather data. For example, the operation center 106 may instruct one or more edge servers of a data center 108 to transmit the weather data to the computing device 110a. In some embodiments, when the closed edge server to the computing device 110a is unavailable or unable to reach the computing device 110a, the next nearest edge server is chosen to provide redundant data delivery.

In some embodiments, the weather data request is a request for previously received weather data. For example, the computing device 110a may request all weather data for a particular 24-hour period. In turn, the operation center 106 transmits the weather data for that 24-hour period to the computing device 110a.

In some embodiments, the weather data request (received at block 410) is a request for continuously updated data. In such embodiments, the operation center 106 automatically pushes the weather data to the computing device, for example, via an auto push server.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Various features and advantages of some embodiments are set forth in the following claims.

What is claimed is:

1. A content delivery system comprising:
a weather satellite;
a region receiver configured to receive weather data from the weather satellite; and
a content delivery network including a plurality of data centers and an operation center communicatively coupled to the plurality of data centers and the region receiver, the operation center configured to
receive the weather data from the region receiver;
store the weather data within at least one of the plurality of data centers;
receive, from a computing device, a user login request to initiate a virtual private cloud associated with the user login request;
in response to receiving the user login request, initiate the virtual private cloud, wherein the virtual private cloud is in communication with the computing device;
receive, through the virtual private cloud, a weather data request; and
in response to receiving the weather data request, transmit the weather data to the computing device to process, store, or both, the weather data and/or for display on a user interface of the computing device.

2. The system of claim 1, wherein each of the plurality of data centers includes an edge server and storing the weather data includes storing the weather data within the edge server.

3. The system of claim 1, wherein at least one of the plurality of data centers includes an archive of previously received weather data and wherein the operation center is further configured to:
receive, through the virtual private cloud, a request for previously received weather data; and
in response to the request for previously received weather data, transmit the previously received weather data to the computing device for display on a user interface of the computing device.

4. The system of claim 1, wherein the weather data is at least one selected from the group consisting of a passive weather radiometer data set and a secondary environment instrument data set.

5. The system of claim 4, wherein the secondary environment instrument data set includes at least one selected from the group consisting of space environment data, geostationary lightning mapper data, ultraviolet and x-ray irradiance data, magnetometer data, and solar ultraviolet imager data.

6. The system of claim 1, wherein the region receiver is configured to receive the weather data from the weather satellite via at least two data streams.

7. The system of claim 1, wherein the system further comprises a second region receiver and wherein the operation center is communicatively coupled to the second region receiver and is further configured to receive second weather data from the second region receiver.

8. The system of claim 1, wherein the operation center includes an auto push server, the auto push server configured to automatically push new weather data to the computing device.

9. The system of claim 1, wherein the weather data is transmitted according to a geostationary operational environmental satellite rebroadcast service.

10. A method for content delivery, the method comprising:
receiving, from a region receiver, weather data from a weather satellite:
storing the weather data within at least one of a plurality of data centers of a content delivery network;
receiving, from a computing device, a user login request to initiate a virtual private cloud associated with the user login request;
in response to receiving the user login request, initiating the virtual private cloud, wherein the virtual private cloud is in communication with the computing device;
receiving, through the virtual private cloud, a weather data request; and
in response to receiving the weather data request, transmitting the weather data to the computing device to process or store the weather data and/or for display on a user interface of the computing device.

11. The method of claim 10, wherein storing the weather data includes storing the weather data within an edge server of at least one of the plurality of data centers.

12. The method of claim 10, further comprising:
receiving, through the virtual private cloud, a request for previously received weather data; and
in response to the request for previously received weather data, transmitting previously received weather data from an archive included in at least one of the plurality of data centers to the computing device for display on a user interface of the computing device.

13. The method of claim 10, wherein receiving weather data includes receiving at least one selected from the group consisting of a passive weather radiometer data set and a secondary environment instrument data set.

14. The method of claim 13, wherein receiving the secondary environment instrument data set includes receiving at least one selected from the group consisting of space environment data, geostationary lightning mapper data, ultraviolet and x-ray irradiance data, magnetometer data, and solar ultraviolet imager data.

15. The method of claim 10, wherein receiving the weather data from the weather satellite includes receiving the weather data via at least two data streams.

16. The method of claim 10, further comprising:
receiving second weather data from the second region receiver.

17. The method of claim 10, further comprising:
automatically pushing the weather data to the computing device via an auto push server.

18. The method of claim 10, wherein transmitting the weather data includes transmitting the weather data according to a geostationary operational environmental satellite rebroadcast service.
